(19) United States
(12) Patent Application Publication
(10) Pub. No.: US 2015/0133597 A1
(43) Pub. Date: May 14, 2015

(54) POLYMER RESIN COMPOSITION

(71) Applicant: EVONIK HANSE GmbH, Geesthacht (DE)

(72) Inventors: Christian Eger, Bardowick (DE); Stephan Sprenger, Oststeinbek (DE)

(21) Appl. No.: 14/601,549

(22) Filed: Jan. 21, 2015

Related U.S. Application Data
(63) Continuation of application No. 11/662,618, filed on Aug. 17, 2009, now abandoned.

(30) Foreign Application Priority Data
Sep. 10, 2014 (EP) 04021553.5

(51) Int. Cl. C08L 9/02; C09D 109/02; C08K 3/36

(52) U.S. Cl. CPC C08L 9/02; C08K 3/36; C09D 109/02
USPC 524/529

(57) ABSTRACT

The invention provides a polymeric composition comprising:
a) at least one resin selected from the group consisting of vinyl ester resins, unsaturated polyester resins, acrylates and methacrylates,
b) at least one copolymer having resin-reactive groups and a glass transition temperature T_{g} of −20° C. or less,
c) nanoparticles having an average particle size dₘₐₓ as measured by means of small-angle neutron scattering (SANS) of 5 to 150 nm.

The compilation according to the invention allows the production of composite materials, coatings, casting compositions, adhesives, and dental materials which have enhanced mechanical properties, particularly enhanced impact strength.

The invention relates to polymeric compositions based on unsaturated polyester resins and/or vinyl ester resins and/or (meth)acrylates. These resins are extensively used in the art as a resin constituent of composite materials, especially fiber composite materials, for coatings, as a casting composition, for the casting for example of electronic components, and also as adhesives and dental materials. From public prior use it is already known that such resins can be modified by heterodisperse incorporation of a modifying copolymer (based for example on a carboxyl-containing butadiene-acrylonitrile rubber) to enhance properties such as, for example, the impact strength.

The invention is based on the object of providing a polymeric composition of the type specified at the outset that has properties improved over those of the aforementioned state of the art.

The polymeric composition of the invention comprises the following constituents:
a) at least one resin selected from the group consisting of vinyl ester resins, unsaturated polyester resins, acrylates and methacrylates,
b) at least one copolymer having resin-reactive groups and a glass transition temperature T_{g} of −20° C. or less,
c) nanoparticles having an average particle size dₘₐₓ as measured by means of small-angle neutron scattering (SANS) of 5 to 150 nm.

Unsaturated polyester resins (in accordance with DIN 7728 also termed UP resins) are described in more detail in, for example, Ullmann's Encyclopedia of Industrial Chemistry, 6th Edition, Volume 28, page 65 ff. For the preparation of polyester resins, polybasic unsaturated dicarboxylic acids, preferably maleic and/or fumaric acid, are first esterified with diols. This gives relatively low molecular mass linear polyesters which contain reactive C—C double bonds in the chain elements. This resin precursor can then be polymerized by copolymerization with a vinyl compound (generally styrene) to give a three-dimensional network of high molecular mass. The vinyl compound used is, as a general rule, styrene, which is simultaneously a solvent for the linear polyester precursors.

Vinyl ester resins (also termed VE resins) are obtained by a preliminary stage of preparing a linear epoxide oligomer which contains, terminally, acrylate or methacrylate groups and hence reactive double bonds. These terminal connections permit crosslinking in a second step, in styrene as a solvent and crosslinking agent. The crosslinking density of VE resins is lower than that of UP resins, since the linear oligomers of the preliminary stage in the case of VE resins contain only terminal double bonds, whereas with UP resins there is a double bond in every repeating unit of the oligomer.

As the acid component of the UP resins it is also possible to use mixtures of saturated and unsaturated difunctional carboxylic acids (and/or their anhydrides). As saturated aromatic acid components it is possible for example to use adipic, glutaric, phthalic, isophthalic, and terephthalic acid and also their derivatives. Preferred unsaturated acids are maleic acid (anhydride) and fumaric acid and also Diels-Alder adducts of maleic anhydride and cyclopentadiene. Diols used are preferably propylene, dipropylene, ethylene, and diethylene glycol, and additionally 2,2-dimethyl-1,3-propanediol, 1,4-butane-diol, 2,2,4-trimethyl-1,3-pentanediol or bisphenol A and also derivatives such as, for example, the diglycidyl ether of tetrabromobisphenol A. The copolymers needed to crosslink the UP resins may at the same time be solvents for the oligomers; with preference styrene is used. Other suitable compounds are, for example, α-methylstyrene, vinyltoluene, methyl methacrylate, et cetera. Difunctional monomers such as divinylbenzene or diallyl phthalate may be added as additional crosslinkers. Other constituents such as curing agents (polymerization initiators such as peroxides, for example), accelerants, pigments, plasticizers, and the like are familiar to the skilled worker.

With VE resins the backbone of the VE oligomer preferably comprises aromatic glycidyl ethers of phenols or epoxidized novolaks. These are esterified terminally with acrylic acid or methacrylic acid. They are used as a solution in the abovementioned solvents, which in general can act simultaneously as crosslinking copolymers. The curing and processing of VE resins are analogous to those of UP resins.

Acrylates and methacrylates (referred to below jointly as acrylates or polyacrylates) are familiar to the skilled worker and are described in, for example, Ullmann's Encyclopedia of Industrial Chemistry, 6th Edition, Volume 28, page 1 ff. The reactive monomers of the polyacrylates are, in particular, esters of acrylic acid or methacrylic acid, but also the acids themselves, and also acrylamides and methacrylamides. Esters of acrylic acid and methacrylic acid are preferred. The preferred esters are linear, branched or cyclic C₁-C₆ alkyl esters and also heterocyclic and aromatic esters. Preferred acrylic esters are methyl methacrylate (MAA), tetrahydrofuryl methacrylate (THFMA), cyclohexyl methacrylate (CHMA), isobornyl methacrylate (IBMA), benzyl methacrylate (BMA), dicyclopentadienyloxyethyl methacrylate (DCPOEMA), tert-butyl methacrylate (tBMA), isobornyl acrylate (IBA), dihydrodicyclopentadienyl acrylate (DHDCPA), tripropylene glycol diacrylate (TPGDA), alkoxylated pentaerythritol tetraacrylate (PPTTA), propoxylated neopentyl glycol diacrylate (NPGPODA), hydroxyethyl methacrylate (HEMA), trimethylolpropane formal acrylate (CTFA), hexanediol diacrylate (HDDA), propoxylated glycerol triacrylate (GPTA), ethoxylated trimethylol-propane triacrylate (TMPEOTA), trimethylolpropane triacrylate (TMPTA), hydroxyethyl methacrylate (HEMA), hydroxypropyl methacrylate (HPMA), butyl-urethane-ethyl acrylate (BUEA), triethylene glycol dimethacrylate (TEGDMA), dipropylene glycol diacrylate (DPGDA), polyethylene glycol (600) diacrylate (PEG(600)DA), bisphenol A ethoxylated (8) diacrylate (BPA8EPDA), pentaerythritol triacrylate (PETIA), pentaerythritol tetraacrylate (PETA), ditrimethylolpropane tetra-acrylate (DiTMPTTA), and dipentaerythritol hexaacrylate (DPHA). Acrylates for the purposes of the invention are also oligomers or still partly reactive acrylate polymers such as, for example, epoxy acrylates, urethane acrylates, melamine acrylates or oligomers of polyacrylates.

The copolymer provided in accordance with the invention must possess reactive groups which can react with groups of the resin and so bind the copolymer chemically into the resin. The term copolymer denotes in this context that the polymer can react chemically with the resin by virtue of these reactive groups. This copolymer with reactive groups may structurally be a homopolymer or copolymer or homooligomer or cooligomer. The copolymer has a glass transition temperature, T_{g}, of −20° C. or less. Within the polymer of the invention, after it has cured, the copolymer forms what are referred to as rubber domains, which possess this stated glass transition temperature. The rubber domains are phases comprising essentially only the copolymer, which have been incorporated into the resin and which bring about modification of the mechanical properties, particularly the impact strength. Within these rubber domains, between the copolymer molecules, for example, it may substantially be only van der Waals forces that act; in the border region with the resin matrix, the copolymer penetrates into the resin matrix, owing to the resin-reactive groups. After it is cured, the polymeric composition of the invention is in a state which can be regarded as a borderline case between a true two-phase system (resin matrix with rubber domains) and an interpenetrating network.

The groups in the copolymer that are reactive with the resin matrix, in accordance with feature b) of claim 1, may in particular be reactive double bonds (vinyl groups or methacrylate groups, for example), epoxy groups or carboxy groups.

A further constituent of the composition of the invention are nanoparticles having an average particle size dₘₐₓ of 5 to 150 nm. A method used to measure the average particle size is that of small-angle neutron scattering (SANS). This measurement method is familiar to the skilled worker and requires no further explanation here. The SANS measurement yields a particle size distribution curve, in which the volume fraction of particles of corresponding size (diameter) is plotted against the particle diameter. The average particle size is defined as the peak of a SANS distribution curve of this kind, in other words the largest volume fraction with particles of corresponding diameter.

The invention is based on the finding that the modification of resins with copolymers that form rubber domains, on the one hand, and with nanoparticles, on the other hand, produces a distinct and unexpected improvement in the mechanical properties of a cured polymeric composition of the invention. After crosslinking and curing, thermosets are obtained which have a considerably enhanced fracture toughness and impact strength, while other important properties characteristic of thermosets, such as strength, heat distortion resistance, and chemical resistance, remain essentially unaffected. A skilled worker could not have expected that the combination of the modification of resin materials with polymers on the one hand and with nanoparticles on the other hand would have a synergistic effect and would produce a significant enhancement of the mechanical properties.

When reference is made in the context of the invention to a polymeric composition, this term embraces not only the as-yet uncrosslinked or uncured mixture of the corresponding constituents, but also a thermoset material produced from such a mixture. The still-reactive mixtures may be either one-component mixtures, which can be induced to react by external influences, or multicomponent mixtures, in which curing to form the thermoset material begins after the components have been mixed.

The glass transition temperature T_{g} of the domains (rubber domains of the copolymer) is preferably not more than −30° C., more preferably not more than −40, −50 or −60° C. With preference it does not go below −100° C. The preferred glass transition temperature also depends on the intended application of the polymeric compositions of the invention.

The fraction of the copolymer in the polymeric composition of the invention is preferably 2% to 30% by weight, preferably 4% to 18% by weight, more preferably 6% to 12% by weight. In some cases the copolymers are not immediately miscible with the resin. When a composition of the invention is being prepared, therefore, it is possible for precursors or prepolymers to be prepared first of all, by chemical reaction of the copolymers with an equimolar fraction or an excess of resin. These precursors are infinitely miscible with all common resins. In the context of the invention, therefore, it is not necessary that the copolymer can still have reactive groups when it is mixed with the other constituents of the polymeric composition. Instead, it is possible to allow these reactive groups to be consumed by reaction with a part of the resin in a preliminary stage, it being possible for this resin fraction to have a molar excess of reactive groups over the reactive groups of the copolymer. The invention accordingly provides a polymeric composition in accordance with the definition of claim 1, irrespective of the sequence in which these constituents are combined and, where appropriate, allowed to react, and of whether this takes place in one stage or in two or more successive process steps. The typical procedures for preparing a mixture with the constituents in accordance with features a) and b) of claim 1 will be briefly outlined.

The modification of the vinyl ester resin with the copolymer in accordance with feature b) may take place as early as during the preparation of the vinyl ester resin oligomers that are subsequently to be crosslinked (synthesis route). By way of example, a carboxy-functional liquid rubber such as the CTBN elucidated later on below can be reacted with an epoxy resin in excess and hence epoxy-functionalized. The reaction product is subsequently reacted further with acrylic acid and/or methacrylic acid, so that the vinyl ester resin oligomers, which are to be cured in a subsequent step, are formed. A mixture of this kind, prepared by the so-called synthesis route, is available commercially: for example, under the names Dion® 9500 from Reichhold or Derakane® 8084 from Dow Chemical.

The second way is the additive route, for which the resin in accordance with feature a) and the copolymer in accordance with feature b) are first prepared separately and then mixed. In this case, as the copolymer, for example, a carboxy-terminated liquid rubber (CTBN, for example) can either be epoxy-functionalized with a diepoxide or vinyl-functionalized with a glycidyl methacrylate (for further details, see below); the liquid rubbers functionalized with reactive groups in this way are then mixed with the vinyl ester resin.

This additive route, as it is called, is also suitable when using unsaturated polyester resins and acrylates as resins.

In the course of the curing of the composition of the invention, phase separation then occurs, and in the resin matrix there is formation of the rubber domains, already described, which are incorporated chemically in the matrix.

The rubber domains in the cured composition preferably possess an average size, as determined by SEM or TEM, of 0.05 to 20 μm, more preferably 0.1 to 10 μm, more preferably 0.2 to 4 μm.

Examples of the copolymers are 1,3-diene polymers with carboxyl groups and further polar, ethylenically unsaturated comonomers. The diene used can be butadiene, isoprene or chloroprene, preferably butadiene. Examples of polar, ethylenically unsaturated comonomers are acrylic acid, methacrylic acid, lower alkyl esters of acrylic or methacrylic acid, such as their methyl or ethyl esters, amides of acrylic or methacrylic acid, fumaric acid, itaconic acid, maleic acid or their lower alkyl esters or monoesters, or maleic or itaconic anhydride, vinyl esters such as vinyl acetate, for example, or, in particular, acrylonitrile or methacrylonitrile. Especially preferred copolymers are carboxyl-terminated butadiene-acrylonitrile copolymers (CTBN), which are offered in liquid form under the trade name Hycar by the company Noveon (formerly B.F. Goodrich). These copolymers have molecular weights of between 2000 and 5000 and acrylonitrile contents of between 10% and 30%. Specific examples are Hycar CTBN 1300 X 8, 1300 X 13, 1300 X 31 or 1300 X 47. CTBN derivatives may likewise be used. Mention may be made, by way of example, of the CTBN derivatives termed CTBNX, in which there are additional acid functions in the chain. Commercially suitable copolymers are, for example, CTBNX 1300 X 9 and CTBNX 1300 X 18.

Other suitable CTBN derivatives are functionalized with epoxy groups or vinyl groups at the end of the linear oligomer. Epoxy functionalization can be achieved by reactions of the terminal carboxyl groups of CTBN with polyfunctional epoxides. Vinyl functionalization is achieved by reaction of these groups with a glycidyl acrylate or glycidyl methacrylate. From the company Noveon, these copolymers are available under the name VTBNX (vinyl-functionalized) or ETBN (epoxy-functionalized). Particular suitability is possessed by VTBNX 1300 X 33, VTBNX 1300 X 43, ETBN 1300 X 40, and ETBN 1300 X 44.

When using polyacrylates, the stated CTBN and CTBN derivatives are likewise suitable as copolymers. Particular preference is given to the reaction products of CTBNX with glycidyl methacrylate, which are available under the name VTBNX.

In the context of the invention, curing systems familiar to the skilled worker, and known for the curing of the resin, are envisaged.

Generally speaking, peroxides and accelerants are used as curing agents. Preference is given to ketone peroxides such as methyl ethyl ketone peroxide, cumene hydroperoxide, cyclohexanone peroxide or acetylacetone peroxide, for example. Examples of accelerants which can be used include cobalt octanoates or vanadium octanoates.

Other curing-agent systems are based on benzoyl peroxides in combination with amines, especially aromatic and/or tertiary amines. If curing takes place at elevated temperatures (about 80° C., for example), it is possible in certain circumstances to do without the addition of accelerants.

A fraction of the curing agent, based on the total amount of resin and curing agent, can preferably be between 4% and 50% by weight.

The nanoparticles are preferably selected from the group consisting of silicon dioxides, carbonates (chalks, for example) and montmorillonite. Particular preference is given to silicon dioxide nanoparticles of the kind disclosed in WO-A 02/083776. The preferred silicon dioxide nanoparticles are substantially spherical and have only slight, if any, agglomeration and/or aggregation. In this way they differ markedly from silicon dioxide particles obtained by flame pyrolysis (fumed silica), in which the elementary particles do not have a spherical form and, moreover, frequently undergo aggregation and/or agglomeration. The nanoparticles are preferably surface-modified in order to prevent or reduce their agglomeration and to facilitate incorporation into the resin matrix. In the case of silicon dioxides, a preferred surface modification is silanization with appropriate silanes.

The silanes may have hydrolyzable and nonhydrolyzable, optionally functional, groups. Examples of hydrolyzable groups are halogen, alkoxy, alkenoxy, acyloxy, oximino, and amino groups. Examples of functional, nonhydrolyzable groups are vinyl, aminopropyl, chloropropyl, aminoethylaminopropyl, glycidyloxypropyl, mercaptopropyl or methacryloyloxypropyl groups. Examples of nonhydrolyzable, nonfunctional groups are monovalent C₁ to C₈ hydrocarbon radicals. Examples of silanes which can be used in accordance with the invention are as follows: γ-aminopropyltrimethoxy-silane, γ-aminopropylmethyldiethoxysilane, γ-amino-propyldimethylmethoxysilane, glycidyloxypropyltri-methoxysilane, methacryloyloxypropyltrimethoxysilane, chloropropyltrimethoxysilane, vinylmethyldimethoxy-silane, vinyltrispropenoxysilane, vinyldimethylbutane oxime silane, vinyltrisbutanone oxime silane, trimethylchlorosilane, vinyldimethylchlorosilane, dimethylchlorosilane, vinylmethylchlorosilane.

The silanes are used preferably in a concentration of 40 to 200 mol % and more preferably of 60 to 150 mol %, based on the molar amount of silanol groups on the surface of the nanoparticles.

The average particle size dₘₐₓ of the nanoparticles is preferably between 6 and 100 nm, more preferably between 6 and 40 nm, more preferably 8 and 30 nm, more preferably 10 and 25 nm. The maximum width at half peak height of the distribution curve of the particle size of the nanoparticles is preferably not more than 1.5 dₘₐₓ, more preferably not more than 1.2 dₘₐₓ, more preferably not more than 0.75 dₘₐₓ. The width at half peak height of the distribution curve is the width (in nm) of the distribution curve at half peak height, in other words at half of the particle volume fraction in the case of the distribution curve peak dₘₐₓ, or (expressed alternatively) the width of the distribution curve at half the height on the y axis (relative to the height of the curve at dₘₐₓ).

The nanoparticles may have a monomodal or multimodal distribution curve. In the case of a monomodal distribution curve, the curve has only one maximum. A multimodal distribution curve has two or more maxima; within the stated range from 5 to 150 nm, therefore, there are two or more maxima dₘₐₓ in the curve. Among the nanoparticles with multimodal distribution curves, particles having a bimodal or trimodal distribution curve are preferred. In the case of multimodal distribution curves, the width of the half peak height curve is determined separately for each maximum.

The invention further provides composite materials which comprise polymeric compositions of the invention. These materials are, in particular, fiber composite materials such as glass or carbon fiber composite materials. The polymeric composition of the invention in a composite material of this kind is the impregnating resin. The impregnating resin is the matrix resin in which the fibers or fabrics are embedded, irrespective of the embedment process. Owing to the very small particle size of the nanoparticles, a polymeric composition of the invention as an impregnating resin is able to penetrate without problems even into densely packed reinforcing fibers of the kind used for high-performance composite materials. This allows the advantageous mechanical properties of the composition of the invention to be developed throughout the component. The fraction of the nanoparticles in the polymeric composition is preferably 3% to 20% by weight, more preferably 6% to 10% by weight. Composite materials of the invention can be used for example for producing printed circuitboards, structural components for vehicles and aircraft, sports equipment, radar masts, windmill sails or the like.

The invention further provides casting compositions which comprise a polymeric composition of the invention. Casting compositions are used in the electrical and electronics industry as electrical insulating resins, as for example when casting coils or transformers, or as die-attached adhesives for bonding components to printed circuitboards. In the case of the casting of coils, the key factor is that the casting composition (the impregnating resin) is able to flow extremely easily and without error through the spaces between the coil windings, which spaces are often just a few pm in size. This is possible without problems for the nanofilled polymeric compositions of the invention. The fraction of the nanoparticles in the polymeric composition is preferably 10% to 50% by weight, more preferably 20% to 50% by weight.

The invention also provides for the use of a polymeric composition of the invention for producing a product selected from the group consisting of composite materials, coatings, casting compositions, adhesives, and dental materials.

The invention is illustrated below with reference to examples. All percentages and fraction figures are weight percentages or parts by weight.

### EXAMPLE 1

### Preparation of Nanoparticles

A commercially customary aqueous alkali metal silicate solution having a water content of 47% and an SiO₂ to Na₂O ratio of 2.4 is diluted with demineralized water to a water content of 97%. 100 parts of this dilute solution are passed at a rate of 20 parts per h through a column, packed with a commercially customary acidic ion exchange resin, and are subsequently supplied to a distillation receiver. In the distillation receiver, the incoming deionized silicate solution is held at boiling temperature, and the water distilled off is removed from the solution. After the end of the feed, the silica sol formed is concentrated, by further heating, to 10 parts. The pH is adjusted to 10.5 to 11.

Portions of one hundred parts of the sol thus prepared are admixed with 2.5 parts of trimethylmethoxysilane and stirred. 2000 parts of isopropanol are added to these mixtures, and the water is removed by atmospheric distillation down to a level of <0.1% as determined by the Karl-Fischer method. In the course of this distillation, about 1900 parts of isopropanol are removed.

The particle size distribution is measured by means of SANS, and gave an average particle size of 23.2 nm; the width at half peak height of the distribution curve was 11 nm.

### COMPARATIVE EXAMPLE

The premix with the constituents in accordance with features a) and b) of claim 1 that is used is Dion® 9500 from Reichhold. This is an epoxy-based vinyl ester resin modified with a CTBN copolymer. The styrene content of the commercially available precursor is approximately 40% by weight. In accordance with this comparative example this resin was cured alone, in other words without nanoparticles, to a molding. The curing-agent system added was 4% by weight of benzoyl peroxide curing agent (BP-50-FT from Peroxidchemie) and 2% by weight of amine accelerant based on dimethyl-aniline (A-305 from Peroxidchemie), and curing was carried out at room temperature for 24 h.

### EXAMPLE 2

90 parts of Dion® 9500 are mixed in a reactor with 20 parts of nanoparticle dispersion of example 1. The isopropanol present in the nanoparticle dispersion is removed by fractional distillation under reduced pressure. The resin filled with 10% of nanoparticles is cured to a molding, as indicated in the comparative example.

### EXAMPLE 3

80 parts of Dion® 9500 are mixed in a reactor with 40 parts of nanoparticle dispersion of example 1, after which the subsequent procedure is as specified in example 2.

Flexural strength, flexural modulus (DIN EN ISO 178) and glass transition temperature (DSC, differential scanning calorimetry) of the moldings obtained were measured as follows:

| | Flexural | Flexural | |
|---|---|---|---|
| | strength | modulus | Tg |
| | (MPa) | (GPa) | (° C.) |
| Comparative | 52.0 | 793 | 104 |
| example | | | |
| Example 2 | 78.5 | 1652 | 105 |
| Example 3 | 82.8 | 1785 | 106 |

1. A polymeric composition comprising:
a) at least one resin selected from the group consisting of vinyl ester resins, unsaturated polyester resins, acrylates and methacrylates,
b) at least one copolymer having resin-reactive groups and a glass transition temperature T_{g} of −20° C. or less,
c) nanoparticles having an average particle size dₘₐₓ as measured by means of small-angle neutron scattering (SANS) of 5 to 150 nm
wherein, during curing of the composition, phase separation occurs wherein said at least one copolymer forms rubber domains in a resin matrix, wherein the rubber domains in the cured composition have an average size of 0.05 to 20 μm.

2. The composition of claim 1, wherein the glass transition temperature T_{g} of the copolymer is −20 to −100° C.

3-18. (canceled)

19. The composition of claim 1, wherein the glass transition temperature T_{g} of the copolymer is −30 to −100° C.

20. The composition of claim 1, wherein the glass transition temperature T_{g} of the copolymer is −40 to −100° C.

21. The composition of claim 1, wherein the glass transition temperature T_{g} of the copolymer is −50 to −100° C.

22. The composition of claim 1, wherein the glass transition temperature T_{g} of the copolymer is −60 to −100° C.

23. The composition of claim 1, wherein the fraction of the copolymer in the composition is 2% to 30% by weight.

24. The composition of claim 1, wherein the fraction of the copolymer in the composition is 4% to 18% by weight.

25. The composition of claim 1, wherein the fraction of the copolymer in the composition is 6% to 12% by weight.

26. The composition of claim 1, wherein the copolymer in the cured composition forms rubber domains having an average size of 0.1 to 10 μm.

27. The composition of claim 1, wherein the copolymer in the cured composition forms rubber domains having an average size of 0.2 to 4 μm.

28. The composition of claim 1, wherein the copolymer is a carboxyterminated butadiene-acrylonitrile (CTBN) or a CTBN derivative.

29. The composition of claim 28, wherein the CTBN derivatives are selected from the group consisting of epoxy-terminated and vinyl-terminated CTBN derivatives.

30. The composition of claim 1, wherein the nanoparticles are selected from the group consisting of silicon dioxides, carbonates and montmorillonite.

31. The composition of claim 1, wherein the average particle size dₘₐₓ of the nanoparticles is between 6 and 100 nm,

32. The composition of claim 1, wherein the average particle size dₘₐₓ of the nanoparticles is between 6 and 40 nm.

33. The composition of claim 1, wherein the average particle size dₘₐₓ of the nanoparticles is between 8 and 30 nm.

34. The composition of claim 1, wherein the average particle size dₘₐₓ of the nanoparticles is between 10 and 25 nm.

35. The composition of claim 1, wherein the maximum width at half peak height of the distribution curve of the particle size of the nanoparticles is not more than 1.5 dₘₐₓ.

36. The composition of claim 1, wherein the maximum width at half peak height of the distribution curve of the particle size of the nanoparticles is not more than 1.2 dₘₐₓ.

37. The composition of claim 1, wherein the maximum width at half peak height of the distribution curve of the particle size of the nanoparticles is not more than 0.75 dₘₐₓ.

38. The composition of claim 1, wherein the nanoparticles have a monomodal or multimodal distribution curve.

39. The composition of claim 38, characterized in that the distribution curve is monomodal, bimodal or trimodal.

40. A composite material, wherein said composite material comprises a polymeric composition of claim 1.

41. The composite material of claim 40, wherein the fraction of the nanoparticles in the polymeric composition is 3% to 20% by weight.

42. The composite material of claim 40, wherein the fraction of the nanoparticles in the polymeric composition is 6% to 10% by weight.

43. A coating characterized in that it comprises a polymeric composition of claim 1.

44. The coating of claim 43, wherein the fraction of the nanoparticles in the polymeric composition is 10% to 50% by weight.

45. The coating of claim 43, wherein the fraction of the nanoparticles in the polymeric composition is 20% to 50% by weight.

46. A casting compound, wherein said casting compound comprises a polymeric composition of claim 1.

47. The casting compound of claim 46, wherein the fraction of the nanoparticles in the polymeric composition is 10% to 50% by weight.

48. The casting compound of claim 46, wherein the fraction of the nanoparticles in the polymeric composition is 20% to 50% by weight.

49. The use of a polymeric composition of claim 1 for producing a product selected from the group consisting of composite materials, coatings, casting compositions, adhesives, and dental materials.
